(19) United States
(12) Patent Application Publication
(10) Pub. No.: US 2015/0181154 A1
(43) Pub. Date: Jun. 25, 2015

(54) METHOD AND SYSTEM FOR PLAYING VIDEO

(71) Applicant: COMPAL ELECTRONICS, INC., Taipei City (TW)

(72) Inventors: Wen-Chieh LEE, Taipei City (TW); Ching-Hsiang LIN, Taipei City (TW); Chiao-Chih CHANG, Taipei City (TW)

(73) Assignee: COMPAL ELECTRONICS, INC., Taipei City (TW)

(21) Appl. No.: 14/221,265

(22) Filed: Mar. 20, 2014

(30) Foreign Application Priority Data
Dec. 19, 2013 (TW) 102147189

(51) Int. Cl. H04N 5/765; H04N 5/445; H04N 7/088; G11B 27/34

(52) U.S. Cl. CPC H04N 5/765; G11B 27/34; H04N 5/445; H04N 7/0885; H04N 2005/44526; H04N 2005/44539

(57) ABSTRACT

The present invention discloses a method for playing a video, which includes the following steps: a selected video is played on a first display unit through a video player. A corresponding script related to the selected video is received through a handheld electrical device. A currently playing time of the selected video is received through the handheld electrical device from the video player. Metadata, which is related to the corresponding script and has a plurality of time stamps, is played through a second display unit of the handheld electrical device according to the currently playing time. During a process that the selected video is played on the first display unit, the handheld electrical device is utilized to re-receive the currently playing time of the selected video from the video player at a preset time interval.

### RELATED APPLICATIONS

This application claims priority to Taiwan Application Serial Number 102147189, filed Dec. 19, 2013, which is herein incorporated by reference.

### BACKGROUND

1. Field of Invention

The present invention relates to a method and a system for playing a video.

2. Description of Related Art

In order to help audience understand program contents of video products, subtitles are provided to display dialogues or information. Hence, audience who is poor or handicapped in hearing can understand the program contents in the video products with the subtitles.

The subtitles can also be used as a written translation of a foreign-language program to make it possible of hearing the original sounds and voices and comprehending the contents of the program for the audience.

The subtitles are usually displayed at the bottom of the screens, by the side of the stages, or at the top of the stages. However, word numbers of the subtitles or display areas for the subtitles are very limited to avoid interfering the program contents of the video product.

Above all, there is a need to keep the display of the subtitles from the limitation the program contents in playing.

### SUMMARY

According to one embodiment of this invention, a method for playing a video is disclosed to display a video and its related metadata respectively on several display units. The method for playing a video includes the following steps:

(a) A selected video is played on a first display unit through a video player.

(b) A corresponding script related to the selected video is received through a handheld electrical device.

(c) A currently playing time of the selected video is received through the handheld electrical device from the video player.

(d) Metadata, which is related to the corresponding script and has a plurality of time stamps, is played through a second display unit of the handheld electrical device according to the currently playing time.

(e) During a process that the selected video is played on the first display unit, the handheld electrical device is utilized to re-receive the currently playing time of the selected video from the video player at a preset time interval.

According to another embodiment of this invention, a system for playing a video is disclosed. The system for playing a video includes a video player, a data transmission interface and a handheld electrical device. The video player includes an output unit and a first processing unit, which are electrically connected with each other. The output unit is electrically connected with a first display unit. The first processing unit is configured to drive the output unit to output frames of a selected video for the first display unit to display. The handheld electrical device includes a second display unit and a second processing unit. The second processing unit receives a corresponding script related to the selected video. The second processing unit receives a currently playing time of the selected video from the video player through the data transmission interface. The second processing unit drives the second display unit to play metadata, which is related to the corresponding script and has several time stamps, according to the currently playing time. During a process that the selected video is played on the first display unit, the second processing unit re-receives the currently playing time of the selected video on the first display unit from the video player through the data transmission interface at a preset time interval.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows.

FIG. 1 is a flow diagram of a method for playing a video according to one embodiment of this invention;

FIG. 2 is an embodiment of a block diagram of a system applying the method for playing a video;

FIG. 3 illustrates a diagram representing a step of re-receiving a currently playing time of a selected video on a first display unit at a preset time interval;

FIG. 4 is a flow diagram of a method for playing a video according to another embodiment of this invention;

FIG. 5 is a flow diagram of a method for playing a video according to still another embodiment of this invention; and

FIG. 6 illustrates a block diagram of a system for playing a video according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

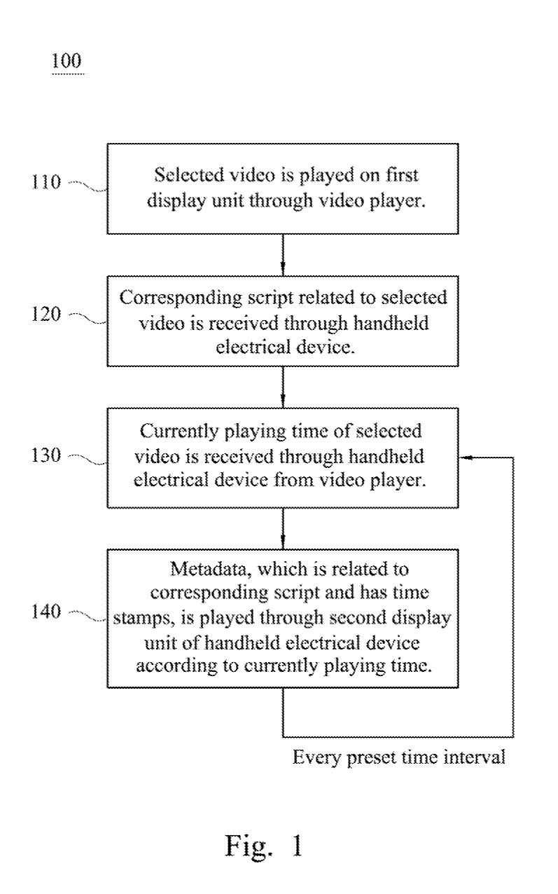

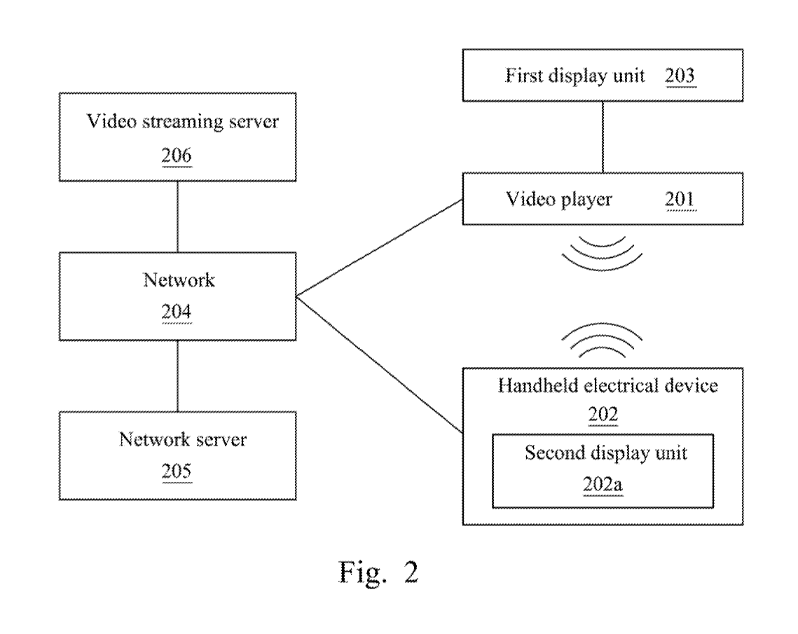

FIG. 1 is a flow diagram of a method for playing a video according to one embodiment of this invention. In the method for playing a video, a video and its related metadata are respectively displayed on several display units. The method for playing a video may take the form of a computer program product (for example, an application (APP) program) stored on a non-transitory computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs), digital versatile disc read only memories (DVD-ROMs), and Blu-ray Disc read only memories (BD-ROMs); magnetic storage devices such as hard disk drives (HDDs); and solid-state disks (SSDs). FIG. 2 is an embodiment of a block diagram of a system applying the method for playing a video. Referring to both FIG. 1 and FIG. 2, the method 100 for playing a video includes the following steps:

At step 110, a selected video is played on a first display unit 203 through a video player 201. In some embodiments of this invention, the first display unit 203 is disposed on a device externally connected to the video player 201. In some other embodiments of this invention, the first display unit 203 is disposed in the video player 201. Moreover, the selected video is pre-stored in a storage unit of the video player 201, or downloaded from a video streaming server 206 through a network 204 by the video player 201.

At step 120, a corresponding script related to the selected video is received through a handheld electrical device 202. When the handheld electrical device 202 receives the corresponding script, the handheld electrical device 202 may generate metadata, which has time stamps, according to the corresponding script, such that the metadata is related to the corresponding script. In some embodiments of step 120, the corresponding script related to the selected video may include subtitles at different playing time, when the selected video is played. Accordingly, the handheld electrical device 202 may generate a subtitle file, which includes subtitles corresponding to the time stamps respectively, according to the corresponding script and take the generated subtitle file as the metadata. In some other embodiments of this invention, the corresponding script related to the selected video may include keywords, related web addresses or any other related information at different playing time, when the selected video is played. Accordingly, the handheld electrical device 202 may search information about the time stamps in the corresponding script from a network server 205 through the network 204 and embed the searched information to the metadata. The network server 205 could be a subtitle server, dictionary server, advertisement server or a server which stores any other related information. For example, the information searched by the handheld electrical device 202 may be related advertisement, meanings of words on the subtitles, or information about the scenarios or subtitles corresponding to the time stamps. Then, the handheld electrical device 202 can generate the metadata by combining the contents or the web addresses of the searched information with the corresponding time stamps. In still some other embodiments of step 120, the corresponding script related to the selected video may include keywords, related web addresses or any other related information at different playing time, when the selected video is played, and combine them with the corresponding time stamps to generate the metadata.

At step 130, a currently playing time of the selected video on the first display unit 203 is received through the handheld electrical device 202 from the video player 201.

At step 140, the metadata, which is related to the corresponding script and has the time stamps, is played through a second display unit 202a of the handheld electrical device 202 according to the currently playing time. Therefore, the video played on the first display unit 203 would not be affected or covered with the metadata played on the second display unit 202a of the handheld electrical device 202. In addition, the metadata played by the handheld electrical device 202 can be synchronized with the video played by the video player 201 according to the received currently playing time. Therefore, complicated procedures to synchronize time settings of the handheld electrical device 202 and the video player 201 in advance are not needed.

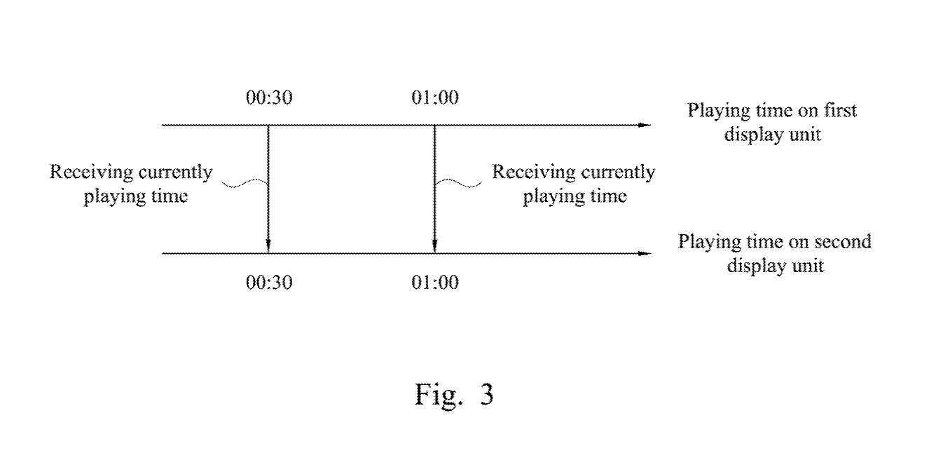

Then, a process that the selected video is played on the first display unit 203, step 130 is performed at a preset time interval, such that the handheld electrical device 202 is utilized to re-receive the currently playing time of the selected video on the first display unit 203 from the video player 201 at the preset time interval. For example, the handheld electrical device 202 can re-receive the currently playing time of the selected video on the first display unit 203 from the video player 201 every 30 seconds (as shown in FIG. 3.) Therefore, it can be confirmed that the playing time on the handheld electrical device 202 can be corresponding to that on the first display unit 203.

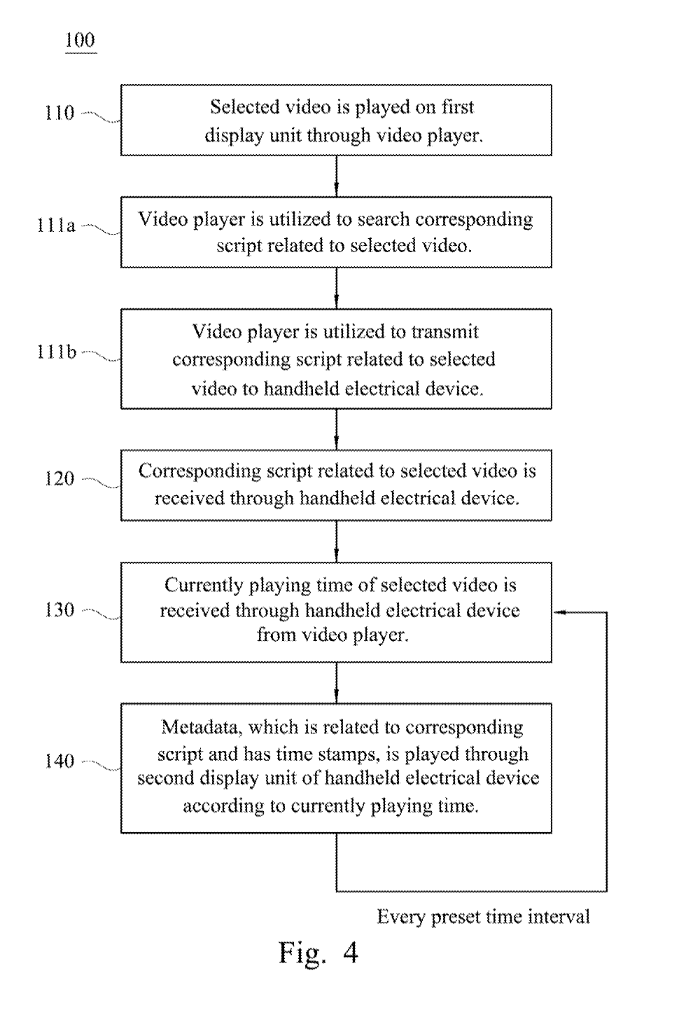

Referring to FIG. 4, a flow diagram will be described that illustrates a method for playing a video according to another embodiment of this invention. It is to be understood that a description of steps identical to those mentioned above will not be repeated. Before the handheld electrical device 202 receives the corresponding script related to the selected video (step 120), the video player 201 may be utilized to search the corresponding script related to the selected video (step 111a). In some embodiments of step 111a, the video player 201 may perform the search to the storage unit of the local host or to the network server 205 through the network 204 according to the file name or any other identification information of the selected video. Then, at step 111b, the video player 201 is utilized to transmit the corresponding script related to the selected video to the handheld electrical device, such that the corresponding script related to the selected video can be received through the handheld electrical device 202 (step 120).

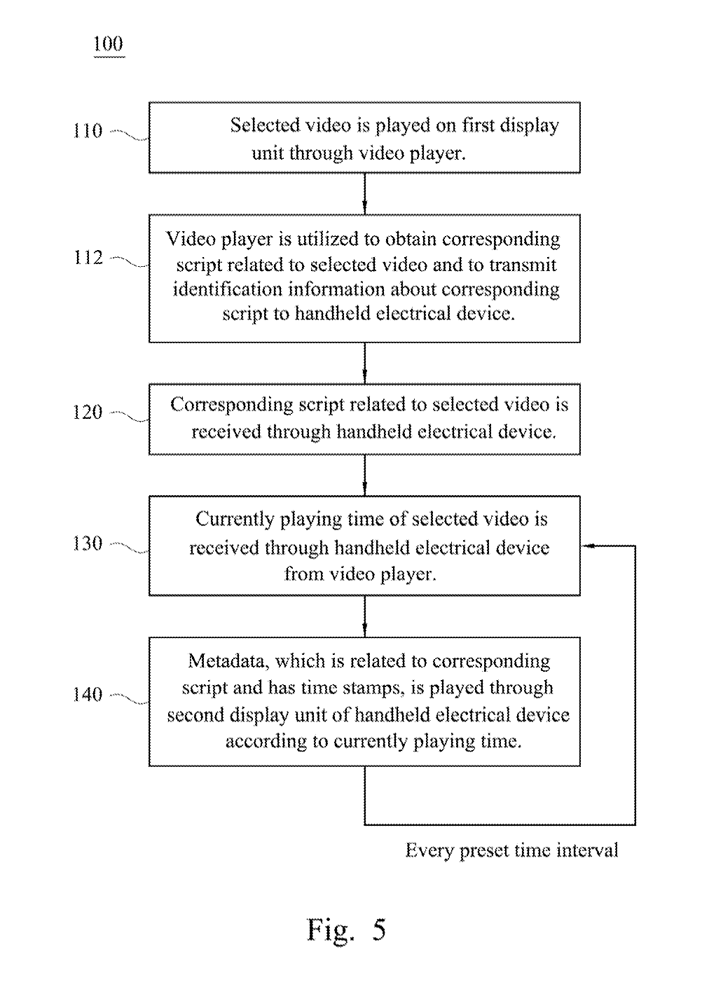

Referring to FIG. 5, a flow diagram will be described that illustrates a method for playing a video according to still another embodiment of this invention. It is to be understood that a description of steps identical to those mentioned above will not be repeated. Before step 120 is performed, the video player 201 may be utilized to obtain the corresponding script related to the selected video, and to transmit identification information about the corresponding script to the handheld electrical device 202 (step 112). Then, step 120 can be performed by utilizing the handheld electrical device 202 to receive the corresponding script (for example, from the network server 205 through the network 204) according to the identification information about the corresponding script. Therefore, the bandwidth required by the video player 201 can be saved.

In some embodiments of the method 100 for playing a video, the handheld electrical device 202 may be utilized to execute an application (APP) program to pair the handheld electrical device 202 with the video player 201. Hence, the handheld electrical device 202 and the video player 201 can detect each other. Then, after the handheld electrical device 202 receives the corresponding script related to the selected video (step 120), the video player 201 transmits the currently playing time of the selected video on the first display unit 203 to the paired handheld electrical device 202, such that step 130 can be performed. Then, the metadata, which is related to the corresponding script and has the time stamps, is played through the second display unit 202a of the handheld electrical device 202 according to the currently playing time (step 140).

In some embodiments of the method 100 for playing a video, when the video player 201 receives a video operating instruction to control the play of the selected video, the video player 201 is triggered to re-transmit the currently playing time of the selected video on the first display unit 203. Such video operating instruction may be PLAY, PAUSE, STOP, FORWARD, BACKWARD or any other instruction to control the play of the selected video. Therefore, even if the selected video is operated, the contents on the display units 203, 202a can still be synchronized′.

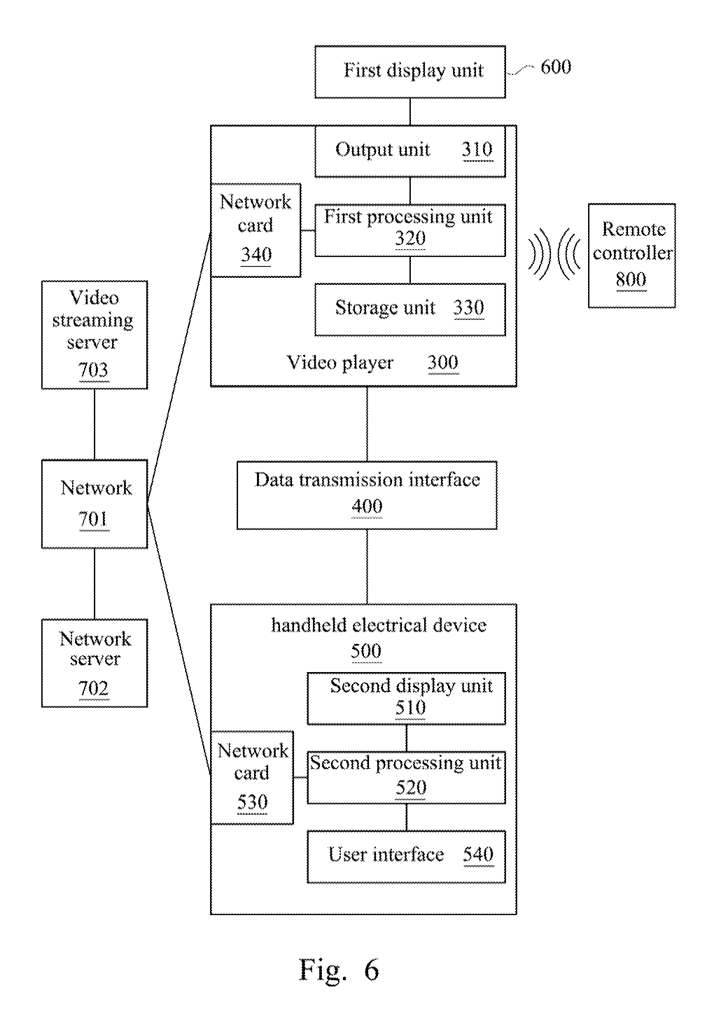

Referring to FIG. 6, a block diagram will be described that illustrates a system for playing a video according to one embodiment of this invention. The system for playing a video includes a video player 300, a data transmission interface 400 and a handheld electrical device 500. The data transmission interface 400 applies a wired or wireless data transmission protocol to transmit data between the video player 300 and the handheld electrical device 500.

The video player 300 includes an output unit 310 and a first processing unit 320, which are electrically connected with each other. The output unit 310 is electrically connected with a first display unit 600. In some embodiments of this invention, the first display unit 600 is disposed on a device externally connected to the video player 300, and the output unit 310 applies High-Definition Multimedia Interface (HDMI), Digital Visual Interface (DVI), Video Graphics Adapter (VGA) or any other video transmission interface to connect to the first display unit 600.

The first processing unit 320 may be a Central Processing Unit (CPU), a control unit, a micro processor, a System on Chip (SOC) or any other hardware able to execute instructions. Steps performed by the first processing unit 320 may be implemented with program codes, such that the first processing unit 320 performs the steps after accessing the program codes.

The first processing unit 320 drives the output unit 310 to output frames of a selected video for the first display unit 600 to display. The selected video is pre-stored in a storage unit 330 of the video player 300, or the first processing unit 320 may drive a network card 340 to download the selected video from a video streaming server 703 through a network 701.

The handheld electrical device 500 includes a second display unit 510 and a second processing unit 520. The second processing unit 520 may be a CPU, a control unit, a micro processor, a SOC or any other hardware able to execute instructions. Steps performed by the second processing unit 520 may be implemented with program codes, such that the second processing unit 520 performs the steps after accessing the program codes.

The second processing unit 520 receives a corresponding script related to the selected video. When the second processing unit 520 receives the corresponding script, the second processing unit 520 may generate metadata, which has time stamps, according to the corresponding script, such that the metadata is related to the corresponding script. In some embodiments of this invention, the corresponding script related to the selected video may include subtitles at different playing time, when the selected video is played. Accordingly, the second processing unit 520 may generate a subtitle file, which includes subtitles corresponding to the time stamps respectively, according to the corresponding script and takes the generated subtitle file as the metadata. In some other embodiments of this invention, the corresponding script related to the selected video may include keywords, related web addresses or any other related information at different playing time, when the selected video is played. Accordingly, the second processing unit 520 may drive the network card 530 to search information about the time stamps in the corresponding script from a network server 702 through the network 701 and embed the searched information to the metadata. The network server 702 could be a subtitle server, dictionary server, advertisement server or a server which stores any other related information. For example, the information searched by the second processing unit 520 may be related advertisement, meanings of words on the subtitles, or information about the scenarios or subtitles corresponding to the time stamps. Then, the second processing unit 520 can generate the metadata by combining the contents or the web addresses of the searched information with the corresponding time stamps. In still some other embodiments of this invention, the corresponding script related to the selected video may include keywords, related web addresses or any other related information at different playing time, when the selected video is played, and the second processing unit 520 combines them with the corresponding time stamps to generate the metadata.

The second processing unit 520 receives a currently playing time of the selected video on the first display unit 600 from the video player 300 through the data transmission interface 400.

The second processing unit 520 drives the second display unit 510 to play metadata, which is related to the corresponding script and has several time stamps, according to the currently playing time. Therefore, the video played on the first display unit 600 would not be affected or covered with the metadata played on the second display unit 510 of the handheld electrical device 500. In addition, the second processing unit 520 can synchronize the metadata played by the handheld electrical device 500 with the video played by the video player 300 according to the received currently playing time. Therefore, complicated procedures to synchronize time settings of the handheld electrical device 500 and the video player 300 in advance are not needed.

During a process that the selected video is played on the first display unit 600, the second processing unit 520 re-receives the currently playing time of the selected video on the first display unit 600 from the video player 300 through the data transmission interface 400 at a preset time interval. Therefore, it can be confirmed that the playing time on the handheld electrical device 500 can be corresponding to that on the first display unit 600.

In some embodiments of this invention, the first processing unit 320 may search the corresponding script related to the selected video. For example, the first processing unit 320 may perform the search to the storage unit 330 of the local host or drives the network card 530 to perform search to the network server 702 through the network 701 according to the file name or any other identification information of the selected video for obtaining the corresponding script. Then, the first processing unit 320 transmits the corresponding script related to the selected video to the handheld electrical device 500 through the data transmission interface 400, such that the corresponding script related to the selected video can be received by the second processing unit 520.

In some other embodiments of this invention, the first processing unit 320 may obtain the corresponding script related to the selected video, and transmits identification information about the corresponding script to the handheld electrical device 500 through the data transmission interface 400. The handheld electrical device 500 may further include a network card 530. The second processing unit 520 may drive the network card 530 to receive the corresponding script according to the identification information about the corresponding script from a network server 702 through a network 701. Therefore, the bandwidth required by the video player 300 can be saved.

In some other embodiments of this invention, the second processing unit 520 executes an application (APP) to pair the handheld electrical device 500 with the video player 300 through the data transmission interface 400. Then, after the second processing unit 520 of the handheld electrical device 500 receives the corresponding script related to the selected video, the first processing unit 320 starts to transmit the currently playing time of the selected video to the paired handheld electrical device 500 through the data transmission interface 400. Then, the second processing unit 520 can drive the second display unit 510 to play the metadata, which is related to the corresponding script and has the time stamps, according to the currently playing time.

In some other embodiments of this invention, when the video player 300 receives a video operating instruction to control the play of the selected video, the first processing unit 320 may re-transmit the currently playing time of the selected video on the first display unit 600. Such video operating instruction may be PLAY, PAUSE, STOP, FORWARD, BACKWARD or any other instruction to control the play of the selected video. The video operating instruction may be generated through a user interface 540 of the handheld electrical device 500 or a remote controller 800. Therefore, even if the selected video is operated, the contents on the display units 510, 600 can still be synchronized.

Although the present invention has been described in considerable detail with reference to certain embodiments thereof, other embodiments are possible. Therefore, the spirit and scope of the appended claims should not be limited to the description of the embodiments contained herein.

It will be apparent to those sidled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for playing a video, comprising:
(a) playing a selected video on a first display unit through a video player;
(b) receiving a corresponding script related to the selected video through a handheld electrical device;
(c) receiving a currently playing time of the selected video through the handheld electrical device from the video player;
(d) playing metadata, which is related to the corresponding script and has a plurality of time stamps, through a second display unit of the handheld electrical device according to the currently playing time; and
(e) during a process that the selected video is played on the first display unit, utilizing the handheld electrical device to re-receive the currently playing time of the selected video from the video player at a preset time interval.

2. The method for playing a video of claim 1, further comprising:
utilizing the video player to search the corresponding script related to the selected video; and
utilizing the video player to transmit the corresponding script related to the selected video to the handheld electrical device.

3. The method for playing a video of claim 1, further comprising:
utilizing the video player to obtain the corresponding script related to the selected video;
utilizing the video player to transmit identification information about the corresponding script to the handheld electrical device; and
utilizing the handheld electrical device to receive the corresponding script according to the identification information about the corresponding script.

4. The method for playing a video of claim 1, further comprising:
utilizing the handheld electrical device to receive the corresponding script and to generate the metadata having the time stamps according to the corresponding script.

5. The method for playing a video of claim 1, further comprising:
utilizing the handheld electrical device to execute an application (APP) program to pair the handheld electrical device with the video player; and
utilizing the video player to transmit the currently playing time of the selected video to the handheld electrical device after the handheld electrical device receives the corresponding script related to the selected video.

6. The method for playing a video of claim 1, wherein the metadata having the time stamps comprises at least one subtitle file having the time stamps or at least one web address having the time stamps.

7. The method for playing a video of claim 1, further comprising:
triggering the video player to re-transmit the currently playing time of the selected video on the first display unit, when the video player receives a video operating instruction to control the play of the selected video.

8. A system for playing a video, comprising:
a video player, comprising:
an output unit, electrically connected with a first display unit; and
a first processing unit, electrically connected with the output unit, wherein the first processing unit executes steps of:
driving the output unit to output frames of a selected video for the first display unit to display:
a data transmission interface; and
a handheld electrical device, comprising:
a second display unit; and
a second processing unit, electrically connected with the second display unit, wherein the second processing unit executes steps of:
receiving a corresponding script related to the selected video;
receiving a currently playing time of the selected video from the video player through the data transmission interface;
driving the second display unit to play metadata, which is related to the corresponding script and has a plurality of time stamps, according to the currently playing time; and
during a process that the selected video is played on the first display unit, utilizing the second processing unit to re-receive the currently playing time of the selected video on the first display unit from the video player through the data transmission interface at a preset time interval.

9. The system for playing a video of claim 8, wherein:
the first processing unit searches the corresponding script related to the selected video, and transmits the corresponding script related to the selected video to the handheld electrical device through the data transmission interface for the second processing unit to receive.

10. The system for playing a video of claim 8, wherein:
the first processing unit obtains the corresponding script related to the selected video, and transmits identification information about the corresponding script to the handheld electrical device through the data transmission interface; and
the handheld electrical device further comprises a network card, wherein the second processing unit drives the network card to receive the corresponding script according to the identification information about the corresponding script from a network server through a network.

11. The system for playing a video of claim 8, wherein:
the second processing unit receives the corresponding script and generates the metadata having the time stamps according to the corresponding script.

12. The system for playing a video of claim 8, wherein:
the second processing unit executes an application (APP) program to pair the handheld electrical device with the video player through the data transmission interface; and
the first processing unit starts to transmit the currently playing time of the selected video to the handheld electrical device through the data transmission interface after the handheld electrical device receives the corresponding script related to the selected video.

13. The system for playing a video of claim 8, wherein the first processing unit re-transmits the currently playing time of the selected video on the first display unit, when the video player receives a video operating instruction to control the play of the selected video.
